(19) United States
(12) Patent Application Publication
(10) Pub. No.: US 2017/0006865 A1
(43) Pub. Date: Jan. 12, 2017

(54) FORMULATIONS FOR CONTROL OF MICROBIAL GROWTH IN SOILLESS POTTING MEDIA

(71) Applicant: Kemin Industries, Inc., Des Moines, IA (US)

(72) Inventors: Emily-Jean Fuerst, Ames, IA (US); John A. Greaves, Ankeny, IA (US)

(21) Appl. No.: 15/186,875

(22) Filed: Jun. 20, 2016

Related U.S. Application Data
(60) Provisional application No. 62/181,298, filed on Jun. 18, 2015.

(51) Int. Cl. A01N 37/02; A01N 31/08

(52) U.S. Cl. CPC A01N 37/02; A01N 31/08

(57) ABSTRACT

A method of controlling microbial growth in soilless potting media is disclosed. The method includes application of an effective amount of a combination of carvacrol and propionic acid (carvacrol propionate) to the soilless potting media.

### REFERENCE TO RELATED APPLICATIONS

This application claims priority to U.S. Patent Application No. 62/181,298, filed Jun. 18, 2015, and incorporates herein in its entirety by this reference.

### BACKGROUND OF THE INVENTION

The invention relates generally to potting soil and, more specifically, to formulations for treating soilless potting mixes to prevent or control microbial growth.

The use of soilless potting mix (SPM) in place of soil is popular in many greenhouses; 349 million US dollars were spent on potting and growing media alone in 2009¹. SPM varies in its makeup, though it usually contains a high percentage of organic matter, such as peat moss and compost, and other materials added to provide aeration and structure, such as perlite and polystyrene foam. As with soil, SPM can harbor microbial pathogens that infect and injure plants with which they come in contact, often referred to as damping off in young seedlings. Botrytis, Fusarium, and Pythium are three genera of organisms known to cause damping off^{2,3}. Botrytis and Fusarium are fungi, whereas Pythium is an oomycete, a class of organisms previously classified with fungi⁴. The presence of chitin in the cell wall of fungi and cellulose in the cell wall of oomycetes differentiates fungi from oomycetes⁴. However, they are frequently grouped together and referred to as fungi today, and they have many of the same pathogenic effects. As such, Botrytis, Fusarium, and Pythium will collectively be referred to as fungi in this study.

It can be a considerable issue for a greenhouse when seeds and/or seedlings are killed due to these microbial pathogens in the soil or SPM. To reduce pathogens, SPM is often steam treated prior to use, but this is a time consuming and costly process that is not ideal for large-scale greenhouse operations. A product is needed that would provide an alternative means to control microbial growth in SPM and which could be applied directly to SPM to hinder the overall growth of microorganisms, thereby controlling damping off in greenhouses.

### SUMMARY OF THE INVENTION

The present invention is a formulation which is applied directly to SPM to hinder the growth of microorganisms, thereby controlling damping off in greenhouses. The formulations used oregano-derived carvacrol distillate, solid calcium propionate, organic acids, or a combination thereof. These active ingredients were carried in inert vermiculite, Sipernat, zeolite, or a mixture of these three materials. The five formulations were applied to SPM in the varying amounts. Treated SPM samples (and untreated SPM controls) were then incubated and tested for carbon dioxide (CO₂) production over a period of time to measure the overall growth of microorganisms in the treated SPM. CO₂ readings indicated that formulations including oregano-derived carvacrol distillate and propionate as active ingredients, were most effective in controlling microbial growth.

### BRIEF DESCRIPTION OF THE DRAWINGS

FIG. 1A and FIG. 1B are charts depicting the enumeration of aerobic plate counts (APC) and yeast and mold counts (YM) in untreated soilless potting mix (SPM). A) APC by SPM layer. B) YM by SPM layer.

FIG. 2 is a chart of CO₂ production in formulation 1 treated soilless potting mix (SPM). Statistical significance for each formulation is indicated (*, p<0.05); Formulation 1 differed significantly from the negative control for at least two days at all treatment levels ≧200 ppm; based on treatment level, significant differences were as follows: 2 days of measurement starting on day 9 at 200 ppm; 5 days of measurement starting on day 7 at 250 ppm; 8 days of measurement starting on day 7 at 375 ppm; 11 days of measurement starting on day 2 at 500 ppm and 625 ppm.; the treatment at 625 ppm had the lowest CO₂ output from day 14 to 25.

FIG. 3 is a chart of CO₂ production in formulation 2 treated soilless potting mix (SPM). Statistical significance for each formulation is indicated (*, p<0.05); Formulation 2 had CO₂ production that was significantly different from the negative control only at the 250 ppm treatment level; it differentiated significantly for 10 days of measurement starting on day 2.

FIG. 4 is a chart of CO₂ production in formulation 3 treated soilless potting mix (SPM) Statistical significance for each formulation is indicated (*, p<0.05); Formulation 3 was significantly different than the negative control at all treatment levels; based on treatment level, significant differences were as follows: 3 days of measurement starting on day 11 at 50 ppm; 11 days of measurement starting on day 2 at 100 ppm; 11 days of measurement starting on day 2 at 150 ppm; 9 days of measurement starting on day 7 at 200 ppm; and 9 days of measurement starting on day 7 at 250 ppm; the treatment at 250 ppm had the lowest CO₂ output from day 14 to 25.

FIG. 5 is a chart of CO₂ production in formulation 4 treated soilless potting mix (SPM). Statistical significance for each formulation is indicated (*, p<0.05); Formulation 4 differed significantly from the negative control for at least one day at all treatment levels except 50 ppm; based on treatment level, significant differences were as follows: 1 day of measurement (day 11) at 100 ppm; 2 days of measurement starting on day 11 at 150 ppm; 5 days of measurement starting on day 11 at 200 ppm; 7 days of measurement starting on day 11 at 250 ppm; the treatment at 250 ppm had the lowest CO₂ output from day 14 to 25.

FIG. 6 is a chart of CO₂ production in formulation 5 treated soilless potting mix (SPM). Statistical significance for each formulation is indicated (*, p<0.05); Formulation 5 was significantly different than the negative control at all treatment levels; based on treatment level, significant differences were as follows: 1 day of measurement (day 11) at 50 ppm; 3 days of measurement starting on day 9 at 100 ppm; 7 days of measurement starting on day 11 for 150 ppm; 8 days of measurement starting on day 9 at 200 ppm; 7 days of measurement starting on day 11 at 250 ppm; the treatment at 250 ppm had the lowest CO₂ output from day 11 to 25.

FIG. 7 is a chart showing the acute knockdown of microorganisms: enumeration of Botrytis, Fusarium, and Pythium in soilless potting mix (SPM) 24 h post-treatment (250 ppm); each measurement represents the average of duplicate platings.

FIG. 8 is a flowchart showing the mechanism of action of propionate as an antifungal.

### DESCRIPTION OF THE INVENTION

In order to test a range of ingredients, a total of five formulations were made. The main active ingredients in all five formulations were carvacrol and/or propionate (Scheme 1).

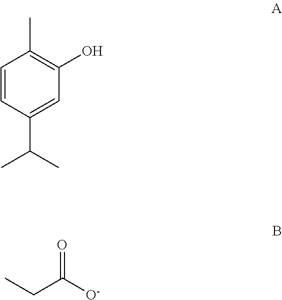

Scheme 1. The Chemical Structures of A) Carvacrol and B) Propionate.

The hydrophobicity of carvacrol allows it to penetrate cell and mitochondrial membranes, disturbing interactions between membrane proteins and lipids and causing membrane expansion⁵. As a result, carvacrol can increase membrane fluidity and permeability, leading to an undesirable movement of ions into and out of the cell and mitochondria. In the mitochondria, this disrupts the electron flow through the electron transport chain, which in turn reduces ATP production and produces free radicals that oxidize and damage lipids, proteins and DNA. The movement of ions and increased reactive oxygen species (ROS) are attributed to the phenolic group of carvacrol⁶. The phenol group is oxidized during membrane permeabilization and leakage giving rise to phenoxyl radicles which continue prooxidant chain reactions and generate new ROS. Prooxidant activities may damage cellular membranes, in particular those of mitochondria, and thus promote the release of calcium, cytochrome C and ROS. In other words, mitochondrial membranes are first damaged by permeabilization resulting in a prooxidant status thereafter.

Propionate acts as an antimicrobial via its effects on metabolic pathways (Scheme 2). Upon interacting with propionate, fungi use the enzyme propionate-Coenzyme A (CoA) ligase to bind propionate and CoA, forming propionyl-CoA⁷. Interestingly, propionate can be used as a fuel source by some organisms, utilizing the methylmalonyl-CoA pathway to convert propionyl-CoA into succinyl-CoA, a product that can be incorporated into the citric acid cycle as an intermediate. However, fungi lack methylmalonyl-CoA mutase, a key enzyme in the pathway. Consequently, fungi withhold an excess of propionyl-CoA, an intermediate that can be deleterious to metabolism in fungi if at too high of concentration. Propionyl-CoA inhibits pyruvate dehydrogenase, which catalyzes the formation of acetyl-CoA from pyruvate. Acetyl-CoA is necessary for the production of citrate, the starting material of the citric acid cycle. Thus, the energy-producing citric acid cycle is inhibited by heightened propionyl-CoA levels. Propionyl-CoA has also been shown to inhibit succinyl-CoA synthase and ATP-citrate lyase, enzymes necessary for anabolism and catabolism, respectively.
Scheme 2. Mechanism of Action of Propionate as an Antifungal.

Propionate ultimately acts by preventing the production of citrate for the citric acid cycle. This decreases the amount of energy that fungi can produce. Components of Scheme 2 that are italicized are enzymes, while boxed components are substrates.

### EXAMPLE 1

### Materials and Methods

In this study, SPM consisting of 75% peat moss, 10% compost, 10% perlite, and 5% polystyrene foam was obtained from De Jong Greenhouses. First, the SPM was plated on selective agar media and it was determined that Botrytis, Fusarium, and Pythium were all present in the SPM at pathogenic levels. Then, five formulations were created. The formulations used oregano-derived carvacrol distillate, solid calcium propionate, organic acids, or a combination thereof. These active ingredients were carried in inert vermiculite, sipernat, zeolite, or a mixture of these three materials. The five formulations were applied to SPM in the amounts of 50, 100, 150, 200, and 250 ppm, and formulation 1 was also tested at higher dosages of 375, 500, and 625 ppm. Treated SPM samples (and untreated SPM controls) were then incubated and tested for carbon dioxide (CO₂) production over 25 days to measure the overall growth of microorganisms in the treated SPM. CO₂ readings indicated that formulations 3 and 5, consisting of oregano-derived carvacrol distillate and propionate as active ingredients, were most effective in controlling microbial growth.

Enumeration of Botrytis, Fusarium, and Pythium in untreated SPM. The SPM was evaluated for the presence and pathogenicity of the three microorganisms of interest: Botrytis, Fusarium, and Pythium. A 1:10 dilution of SPM (75% peat moss, 10% compost, 10% perlite, 5% polystyrene foam, De Jong Greenhouses, Pella, Iowa) was created by diluting 10 g SPM in 90 ml sterile Milli-Q water in a sterile 150 ml glass bottle. This dilution was performed in triplicate; specifically, SPM was sampled three times, once from the top, middle, and bottom of a large container in which the SPM was stored to account for possible discrepancies in microbial activity between the layers. The 1:10 dilution was then shaken at 300 revolutions per minute (RPM) for 60 min to hydrate the sample. Using aseptic technique, 1 ml of the 1:10 dilution was withdrawn and placed into 9 ml sterile water in a sterile 15 ml tube to make a 1:100 dilution. Serial dilutions were performed in this manner until a 1:1,000,000 dilution of SPM was reached. These dilutions were made on the day of plating on the selective agar media.

Botrytis selective medium⁸ (BSM) was used to isolate Botrytis, malachite green agar⁹ (MGA) medium was used to isolate Fusarium, and nystatin-ampicillin-rifampicin-miconazole¹⁰ (NARM) medium was used to isolate Pythium. The composition of each selective medium is provided in Tables 1, 2, and 3. To prepare the mediums, all ingredients of each medium were combined except the respective antibiotics and autoclaved for 30 min at 121° C. with 15 psi. Solutions of antibiotics were made by dissolving the antibiotics in appropriate solvents. For BSM, a stock solution of chloramphenicol was made in 100% ethanol (Fisher, Waltham, Mass., catalog S25307B) at 20 mg/ml. For MGA media, a chloramphenicol stock solution (20 mg/ml) was prepared as described, and a stock solution of streptomycin sulfate was prepared in sterile water (100 mg/ml). For NARM media, nystatin was dissolved in 100% ethanol at 10 mg/ml, ampicillin was dissolved in sterile water at 100 mg/ml, rifampicin was dissolved in DMSO (Sigma, St. Louis, Mo., D8418-100ML) at 10 mg/ml, and miconazole was dissolved in DMSO at 1 mg/ml. All antibiotic solutions were filter (0.22 μm) sterilized with the exception of nystatin, which was unable stay in solution when passing through the filter. After the media was autoclaved, it was allowed to cool (˜50° C.). The appropriate amount of antibiotic solution was then added to the media. The medium was stirred with a magnetic stir bar for 1-2 min before plating.

TABLE 1
Botrytis selective medium (BSM) was
used for the isolation of Botrytis^{§}.

| | Quantity per | |
|---|---|---|
| Ingredient | Liter (g) | Vendor^{‡}, Catalog |
| D-Glucose | 2.00 | Fisher, D16-500 |
| Sodium nitrate | 0.10 | Fisher, S343-500 |
| Dipotassium phosphate | 0.10 | Fisher, P288-3 |
| Magnesium sulfate | 0.20 | Acros Organics, 213115000 |
| heptahydrate | | |
| Potassium chloride | 0.10 | Fisher, SP135-500 |
| Pentachloronitrobenzene | 0.02 | Fisher, ICN220907 |
| Manganese ethylene | 0.02 | Fisher, ICN221736 |
| bisdithiocarbamate | | |
| Rose bengal disodium salt | 0.05 | Fisher, R323-25 |
| Tannic acid | 0.05 | Sigma, T-8406 |
| Chloramphenicol* | 0.20 (10 mL) | Amresco, 0230-100G |
| Granulated agar | 20.0 | Fisher, BP1423-500 |

^{§}Prior to autoclaving, the pH was adjusted to 6.5 with 1N hydrochloric acid (Fisher, catalog SA48-4).
^{‡}Acros Organics is owned by Fisher Scientific. Amresco is located in Solon, OH.
*Antibiotic in solution.

TABLE 2
Malachite green agar (MGA) media was used
for the isolation of Fusarium.

| | Quantity per | | |
|---|---|---|---|
| Ingredient | Liter | | Vendor^{‡}, catalog # |
| Soytone peptone AM41 | 15.0 | g | Organotechnie, AI230 |
| Monopotassium phosphate | 1.0 | g | Fisher, P-285-3 |
| Magnesium sulfate | 0.5 | g | Acros Organics, 213115000 |
| heptahydrate | | | |
| Malachite green oxalate salt | 2.5 | mg | Fisher, M-29025 |
| Chloramphenicol* | 0.2 g | (10 ml) | Amresco, 0230-100G |
| Streptomycin sulfate* | 0.5 g | (5 ml) | Fisher, BP910-50 |
| Granulated agar | 20.0 | g | Fisher, BP1423-500 |

^{‡}Organothechnie is located in La Courneuve, France.
*Antibiotic in solution.

TABLE 3
Nystatin-ampicillin-rifampicin-miconazole (NARM)
media was used for the isolation of Pythium.

| | Quantity per | | |
|---|---|---|---|
| Ingredient | Liter | | Vendor, catalog # |
| Nystatin* | 0.01 g | (1 ml) | Fisher, BP2949-5 |
| Ampicillin* | 0.25 g | (2.5 ml) | Fisher, BP1760-25 |
| Rifampicin* | 0.01 g | (1 ml) | Fisher, BP2679-250 |
| Miconazole* | 1.0 mg | (1 ml) | Fisher, ICN19391505 |
| Corn meal agar | 17.0 | g | Fisher, B11132 |
| Granulated agar | 23.0 | g | Fisher, BP1423-500 |

*Antibiotic in solution.

Each of the dilutions of SPM from each layer (top, middle, and bottom) was plated (1 ml) onto the three selective media plates, in duplicate. BSM and NARM plates were incubated in the dark at room temperature (RT, 22-25° C.) for 6 days. MGA plates were incubated at 28 ° C. in the dark for 6 days. The number of colonies on the plates was counted, and the number of colony forming units (CFU) per ml was determined by multiplying the number of colonies by the reciprocal of the dilution level.

Evaluation of untreated SPM on Petrifilm™ plates. Dilutions of SPM were performed in the same manner as described for plating on selective agar media, except SPM was diluted in sterile buffered water in lieu of sterile water. Buffered water was prepared by making 1 L of potassium phosphate stock solution (PPSS, 10 g sodium hydroxide (NaOH, Fisher, catalog S318-1), 34 g monopotassium phosphate, pH adjusted to 7.2 with 1 M NaOH, volume brought to 1 L with Milli-Q water, autoclaved for 30 min at 121° C. and 15 psi to sterilize). PPSS (1.25 ml) was then diluted to 1 L with sterile water to make buffered water. These dilutions of SPM from each layer (top, middle, and bottom) were plated (1 ml) in duplicate on 3 MTM (St. Paul, Minn.) Petrifilm for total aerobic plate count (APC, Aerobic Count Plates, catalog 6400) and yeast and mold (YM, Rapid Yeast and Mold Count Plates, catalog 6407) evaluations following manufacturer guidelines. APC plates were left to incubate for 48±3 h at 35±1° C., and YM plates were left to incubate for 5 days at 22° C. The number of colonies on the plates were then counted, and the number of CFU were determined by multiplying the number of colonies by the reciprocal of the dilution level.

Preparation of formulations. Five different formulations were made (50 g) as indicated by Table 4. Oregano carvacrol distillate was obtained from Kemin Personal Care (KPC, Des Moines, Iowa) and all other ingredients were obtained from Kemin Animal Nutrition and Health, North America (KANA, Des Moines, Iowa). For formulations 1 and 3, zeolite and vermiculite were manually mixed by hand for 1-2 min until visually homogeneous, and then the oregano carvacrol distillate was slowly added with manual mixing for 5 min to ensure homogenization and dry dispersion. Then the SHIELD™ Granules Feed Grade (dry pelleted calcium propionate; Kemin Industries, Des Moines, Iowa) was added and manually mixed for 2 min for formulation 3. For formulation 2, all ingredients were combined and manually mixed for 2 min for visual homogenization. For formulations 4 and 5, the solid benzoic acid was added to the liquid propionic acid and mixed with a magnetic stir bar on a stir plate for 10 min at RT until the benzoic acid dissolved. Then, the liquid phosphoric acid was added and mixed on the same stir plate for 5 min at RT. The oregano carvacrol distillate was first added to the solid ingredients and manually mixed as previously described. Then, the blend of acids was added to the mixture of oregano carvacrol distillate and solid ingredients. All ingredients were then manually mixed for 5 min until homogeneous.

TABLE 4
Formulations*.

| | | Formulation | | | | |
|---|---|---|---|---|---|---|
| | | 1 | 2 | 3 | 4 | 5 |
| | | % | % | % | % | % |
| Ingredient | Catalog | Inclusion | Inclusion | Inclusion | Inclusion | Inclusion |
| Propionic acid | RM01141 | — | — | — | 40.0 | 40.0 |
| Benzoic acid | RM14496 | — | — | — | 5.0 | 5.0 |
| Phosphoric acid | RM01138 | — | — | — | 5.0 | 5.0 |
| (75%) | | | | | | |
| Oregano carvacrol | M018038 | 10.6 | — | 10.6 | — | 10.6 |
| distillate (94.7%) | | | | | | |
| SHIELD ™ | | | | | | |
| Granules Feed | 011458 | — | 70.1 | 70.1 | — | — |
| Grade | | | | | | |
| Vermiculite (dark) | RM01120 | 79.4 | 29.9 | 12.7 | 25.0 | 19.7 |
| Sipernat (22-FG, K) | RM01105 | — | — | — | — | 19.7 |
| Zeolite (40 Mesh) | RM16188 | 10.0 | — | 6.6 | 25.0 | — |

*The formulations used propionic acid, benzoic acid, phosphoric acid, oregano carvacrol distillate, SHIELD Granules Feed Grade (solid calcium propionate) or a combination thereof as active ingredients. Vermiculite, sipernat, and zeolite served as inert carriers for the formulations.

Treatment of SPM with formulations. Formulations 2, 3, 4 and 5 were tested at 50, 100, 150, 200, and 250 ppm. Formulation 1 was tested at 50, 100, 150, 200, 250, 375, 500, and 625 (100 and 250 ppm levels were tested twice). More treatment levels were tested for formulation 1 because of its carvacrol only-based formulation. Untreated SPM was included as a control.

Prior to treating the SPM, all SPM was placed in a clean 55 gallon drum. The drum was manually rolled and agitated for approximately 5 min to thoroughly mix and homogenize the SPM. To prepare each treatment, the appropriate amount of each formulation (0.10, 0.20, 0.30, 0.40, 0.50, 0.75, 1.00, or 1.25 g to give 0, 50, 100, 150, 200, 250, 375, 500, or 625 ppm, respectively) was weighed and added to 200 g SPM. The treated SPM samples were allowed to mix for 2-5 min using a small KitchenAid™ (St. Joseph, Minn.) mixer with a paddle attachment. The treated SPM was then weighed into three 60 g aliquots, each of which was placed in a sterile 1 L glass chamber¹¹. Any remaining treated SPM (approximately 20 g) was placed into a quart-sized Ziploc™ bag to save for microbiology testing on APC, YM, and selective agar media. Then, 150 ml sterile water was added to each chamber. Chamber lids were tightly screwed onto the bottles, and the valves were closed. The bottles were stored in a dark room at RT.

Measurement of CO₂ production. Starting on day zero, the treated SPM was tested for CO₂ production with a Guardian NG Infrared Gas Monitor (Edinburgh Sensors, Livingston, UK, Model 200870). Day zero represented the day on which sterile water was added to the treated SPM. The instrument utilized two tubes: one tube expelled air, while the other drew air into the instrument for analysis. The tubes from the gas monitor were placed into the two valves on the lids of the glass chambers, and the valves were then opened simultaneously to allow gas from the chamber to flow into the instrument. Once the reading on the CO₂ monitor stabilized (˜1-2 min), the % CO₂ of the sample was recorded. The valves on the chamber were closed simultaneously, and the tubing from the instrument was then removed. The CO₂ gas monitor was allowed to stabilize to the ambient air, with a baseline typically around 0.06%, before the next sample was evaluated. The CO₂ production was monitored in this manner at regular intervals for 25 days until the CO₂ chamber appeared to be saturated (˜20% CO₂). To normalize for any initial variances in CO₂ production, the CO₂ measurement on day zero was subtracted from all subsequent readings. Multiple-sample comparison ANOVA was performed with StatGraphics® Centurion XV.II (Statpoint Technologies, Inc. Warrenton, Va.) for statistical analysis of CO₂ production from formulations over time as compared to the untreated SPM.

Microbiological evaluation of treated SPM. The treated SPM was tested on APC, YM, and selective agar media plates (BSM, MGA, and NARM) 24 h after treatment to test for an acute knockdown of microorganisms. Testing dilutions were performed in the same manner as the aforementioned testing on APC, YM, and selective agar media plate, except for formulations 1 (375, 500, and 625 ppm), and 4 and 5 (100, 150, 200, and 250 ppm) where the 1:10 dilution was omitted, and the first dilution (1:100) was made by placing 1 g of the treated SPM in 99 ml sterile buffered water. Then, 1 ml of the 1:100 dilution was placed in 9 ml buffered water to make a 1:1000 dilution. Serial dilutions were performed in this manner up to 1:1,000,000, then 1 ml aliquots of various dilutions (from 1:10 to 1:1,000,000) were plated on APC and YM plates and incubated as described previously. When plating on selective agar media 1 ml of various dilutions (1:10 up to 1:1000) were plated on MGA, NARM, and BSM, and incubated as described previously. All colonies were counted to determine CFU as described previously.

In order to more clearly compare the immediate impact of the 5 formulation simultaneously on the 3 fungal pathogens, a third round of SPM was treated with 250 ppm of each formulation and selective media agar were plated. Treated SPM was diluted 1:100, 1:1000, and 1:10,000 as described previously and 1 ml of each dilution was plated onto MGA, NARM, and BSM, respectively. All colonies were counted to determine CFU as described previously.

### Results

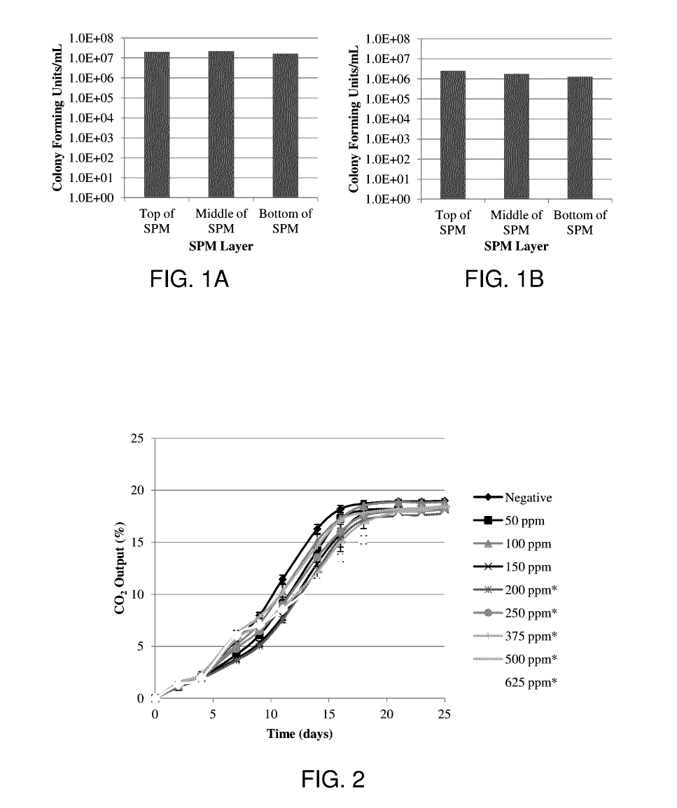

Enumeration of APC, YM, and Botrytis, Fusarium, and Pythium in untreated SPM. The SPM layers (top, middle, and bottom) showed minor differences in APC and YM counts (FIG. 1), but were all within 0.5 log of each other. The average APC count was 2.0E+07 CFU and YM count was 1.9E+06 CFU. Counts of Botrytis, Fusarium, and Pythium found in untreated soilless potting mix (SPM) are shown in Table 5. Botrytis was present at higher levels in the SPM as compared to Pythium and Fusarium, approximately 14- to 106-fold higher, respectively. The counts for each were at pathogenic levels (Table 5).

TABLE 5
Enumeration of Botrytis, Fusarium, and Pythium
counts in untreated soilless potting mix (SPM) compared to pathogenic
levels reported in the literature¹²⁻¹⁵.

| | Botrytis^{12, 13} | Fusarium¹⁴ | Pythium¹⁵ |
|---|---|---|---|
| Minimum CFUs for | 1.00E+04 | 166 | 10 |
| Pathogenicity | | | |
| Observed CFUs in | 2.73E+04 | 257 | 1900 |
| SPM | | | |

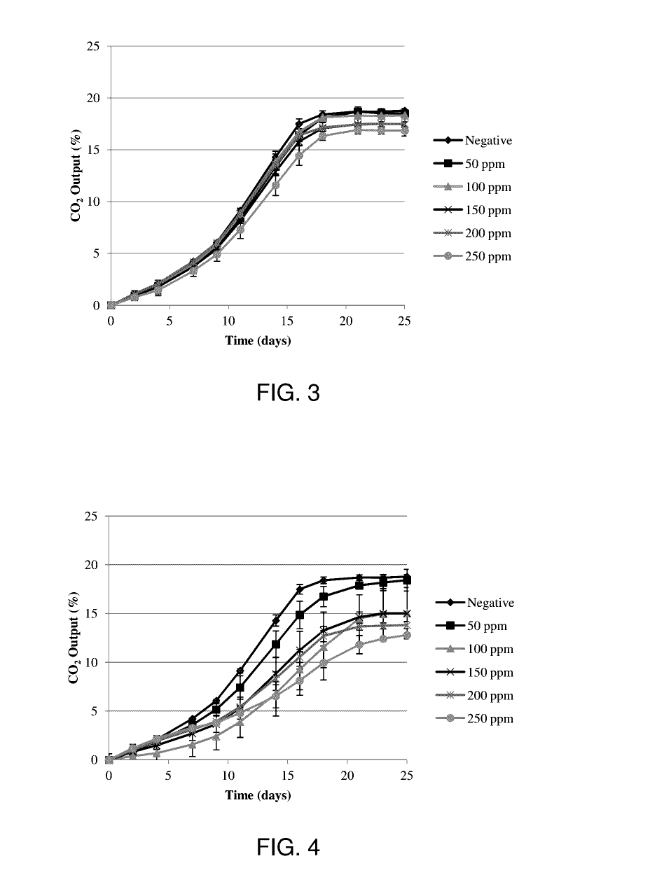

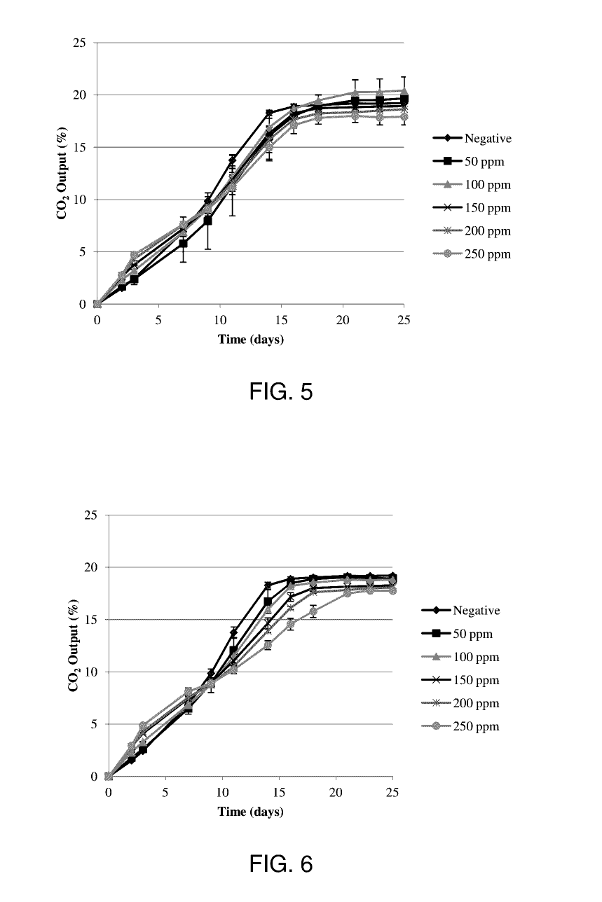

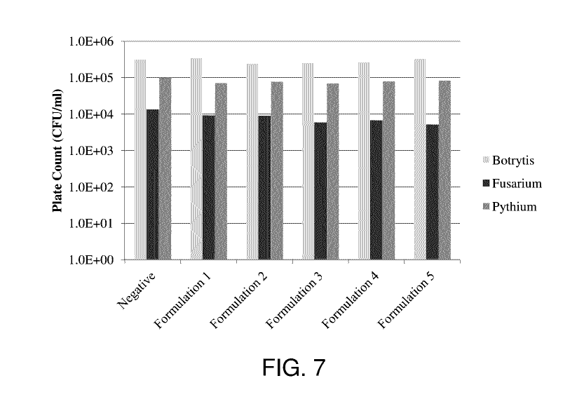

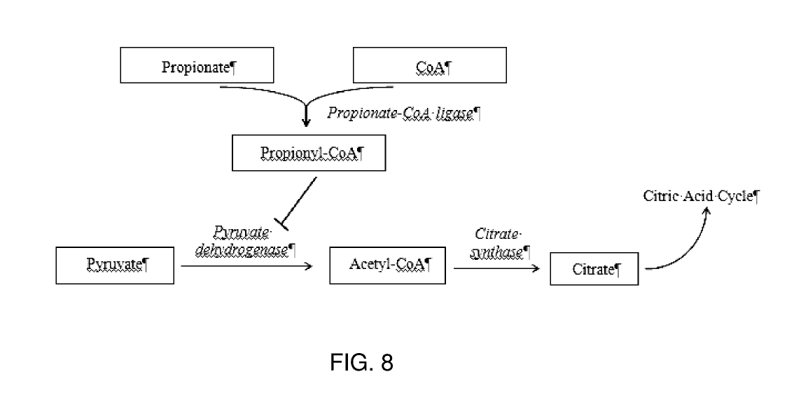

CO₂ production of treated SPM. The CO₂ production of the SPM treated with the formulations are shown in FIGS. 2-6. Each data point is the average of three measurements from one experiment, except for formulation 1, where the 100 and 250 ppm treatments were repeated in two experiments, thus the average of both experiments are shown. The first day (day 0) of CO₂ readings were subtracted from each sample, giving a consistent starting point for all samples. The CO₂ monitor reached saturation at approximately 21%, as shown by the plateau in CO₂ readings that occurred toward the end of the time period. Some readings appeared to level off below 21% because the day zero was slightly higher for those samples. All experimental samples showed increasing CO₂ production over time.

As shown in FIGS. 2-6, each formulation resulted in a dose dependent decrease in CO₂ production as compared to the control. Formulations 3 and 5 were the only two formulations for which all treatment levels gave CO₂ production that was significantly (p<0.05) different than the control. These two formulations utilized both carvacrol and propionate or propionic acid as active ingredients.

Evaluation of the treated SPM for acute microbial knockdown following treatment with the formulations is shown in Table 6. For APC and YM it was observed that representatively similar log counts were obtained for the formulations in comparison to the untreated negative control SPM with exceptions to formulations 4 and 5 and at levels >150 ppm. For the 3 fungal pathogens, it was found that the counts were maintained and were representative of the untreated control. For formulations 2 and 3 the fungal pathogens were too numerous to count (TNTC).

TABLE 6
Acute knockdown of microorganisms: enumeration of aerobic plate counts
(APC), yeast and mold counts (YM), and Botrytis, Fusarium, and
Pythium in soilless potting mix (SPM) 24 h post-treatment*.

| | Dose | | | | | |
|---|---|---|---|---|---|---|
| Formulation | (ppm) | APC | YM | Botrytis | Fusarium | Pythium |
| Negative | 0 | 1.06E+08 | 1.04E+06 | 6.60E+04 | 4.00E+04 | 4.30E+04 |
| Formulation 1 | 50 | 9.95E+07 | 1.93E+06 | TNTC | TNTC | TNTC |
| | 100 | 1.32E+08 | 2.11E+06 | 5.40E+04 | 4.75E+04 | 5.30E+04 |
| | 150 | 1.22E+08 | 1.83E+06 | TNTC | TNTC | TNTC |
| | 200 | 1.92E+08 | 1.31E+06 | TNTC | TNTC | TNTC |
| | 250 | 2.18E+08 | 1.51E+06 | 4.80E+04 | 3.05E+04 | 4.25E+04 |
| | 375 | 2.42E+07 | 5.30E+05 | TNTC | 4.10E+04 | 5.95E+04 |
| | 500 | 2.54E+07 | 2.00E+05 | 3.80E+04 | 2.80E+04 | 4.15E+04 |
| | 625 | 2.61E+07 | 2.60E+05 | 4.30E+04 | 2.20E+04 | 4.00E+04 |
| Formulation 2 | 50 | 1.28E+08 | 1.09E+06 | TNTC | TNTC | TNTC |
| | 100 | 1.45E+08 | 1.08E+06 | TNTC | TNTC | TNTC |
| | 150 | 1.52E+08 | 2.35E+06 | TNTC | TNTC | TNTC |
| | 200 | 4.10E+07 | 1.59E+06 | TNTC | TNTC | TNTC |
| | 250 | 3.85E+07 | 2.58E+06 | TNTC | TNTC | TNTC |
| Formulation 3 | 50 | 1.63E+08 | 1.27E+06 | TNTC | TNTC | TNTC |
| | 100 | 2.16E+08 | 1.02E+06 | TNTC | TNTC | TNTC |
| | 150 | 7.80E+07 | 2.20E+06 | TNTC | TNTC | TNTC |
| | 200 | 2.07E+08 | 1.92E+06 | TNTC | TNTC | TNTC |
| | 250 | 6.75E+07 | 4.10E+06 | TNTC | TNTC | TNTC |
| Formulation 4 | 50 | 4.65E+07 | 4.65E+05 | 5.70E+04 | 4.30E+04 | 6.10E+04 |
| | 100 | 2.70E+07 | 3.80E+05 | 6.20E+04 | 3.90E+04 | 5.50E+04 |
| | 150 | 1.72E+07 | 3.15E+05 | 5.50E+04 | 1.45E+04 | 6.10E+04 |
| | 200 | 1.01E+07 | 3.90E+05 | 7.40E+04 | 3.05E+04 | 5.65E+04 |
| | 250 | 7.50E+06 | 2.95E+05 | TNTC | 2.75E+04 | 5.25E+04 |
| Formulation 5 | 50 | 3.22E+07 | 2.35E+05 | TNTC | 3.90E+04 | 6.80E+04 |
| | 100 | 2.23E+07 | 2.90E+05 | 6.20E+04 | 1.65E+04 | 6.35E+04 |
| | 150 | 1.44E+07 | 4.45E+05 | 5.25E+04 | 2.50E+04 | 5.45E+04 |
| | 200 | 1.00E+07 | 3.65E+05 | 8.50E+04 | 3.10E+04 | 5.30E+04 |
| | 250 | 7.10E+06 | 3.95E+05 | 5.35E+04 | 4.15E+04 | 5.00E+04 |

*Each measurement represents the average of duplicate platings.
TNTC = colonies were too numerous to count.

SPM treatment at 250 ppm for the five formulations and plating for the 3 fungal pathogens were repeated in order to compare the different formulations simultaneously (FIG. 4). The counts for Botrytis and Pythium for the 5 different formulations were maintained and were representative of the untreated control. The Fusarium counts appeared to be more affected, with formulations 3-5 having the greatest observed reduction from the untreated control. However, all counts were within 1 log of the negative control, regardless of treatment.

### Discussion

Five formulations were tested for efficacy in inhibiting the growth of microorganisms in SPM, with the goal of decreasing damping off in young seedlings. Platings on APC, YM, and selective agar media plates revealed that the formulations did not lead to an acute knockdown in microbial counts when comparing untreated and treated SPM. However, subsequent CO₂ monitoring of treated SPM showed long term effectiveness of controlling microbial growth, and revealed formulations 3 and 5 as the most efficacious. Formulations 3 and 5 worked at the lowest dosage (50 ppm) and were the only formulations to include a combination of carvacrol and propionate as antimicrobials. The results also indicated that carvacrol and propionate or cpropionic acid, respectively, were working synergistically. The combination of the two active ingredients controlled CO₂ production better than carvacrol and propionate individually and the effect was not merely additive. The combination of carvacrol affecting membrane fluidity, altering ATP production, and creating ROS and propionate inhibiting metabolism appeared to be a potent blend of diverse antimicrobial mechanisms.

A peculiar trend in some treatments, such as with formulations 3, 4, and 5, was that samples with higher doses emitted more CO₂ on the first few days of incubation compared to samples with lower doses. This contrasts the end of the trials, wherein samples with higher treatment levels emitted less CO₂. A review of the literature found that fungi treated with propionate (i.e. anion form of propionic acid) need to produce more energy to cope with the metabolic harm caused by propionate, thereby initially expelling more CO₂ in an attempt to recoup the metabolic deficit⁷. This explains the early spike in CO₂ levels for samples treated with higher doses of. CO₂ output subsequently leveled off after this spike, and SPM treated with higher doses ended the trial with the lowest CO₂ output. This was likely due to the overwhelming metabolic harm over time caused by propionate, which eventually reduced microbial activity, thereby lowering CO₂ production.

### EXAMPLE 2

The purpose of these trials was to assess the efficacy of a combination of the plant extract carvacrol and propionate in suppressing diseases caused by two widespread and economically damaging soilborne fungi: Fusarium oxysporum and Thielaviopsis basicola.

The study was performed in three steps: 1) obtaining the pathogens and host-plant (tomato and cantaloupe) seeds; 2) validating an inoculation system for each pathogen on tomato and cantaloupe; and 3) evaluating efficacy of the carvacrol/propionate product in suppressing seedling diseases of tomato and cantaloupe in the greenhouse.

### Step 1. Obtaining Pathogens and Host-Plant Seeds

Isolates of two soilborne pathogens (Fusarium oxysporum and Thielaviopsis basicola, Rhizoctonia solani, and Phytopthora cactorum) were obtained from the Department of Plant Pathology and Microbiology at Iowa State University. Isolates were transferred and grown on appropriate media for each pathogen.

Methods to prepare inoculum were developed for each pathogen from protocols provided by colleagues and found in published papers in the scientific literature.

The first step for generating inoculum for F. oxysporum was created by soaking white pearl millet in water for 24 hours. Seeds were drained before placing in tape-sealed vented autoclave bags (MycoSupply) and autoclaving twice for 1 hour each time, with 18 to 24 hours between the first and second autoclaving. Twenty-four hours after the second autoclaving, agar plates containing colonies of each pathogen were cut into 1 cm² squares, deposited into the bags of millet, thoroughly mixed by shaking, and incubated in the appropriate temperature and light/dark regime for each pathogen. Bags were checked daily and gently mixed to break up clumps of mycelia. When millet appeared to be evenly colonized, it was dried in a biosafety cabinet for 2-4 days then stored in airtight bags in the dark.

Inoculum for T. basicola was prepared as a chlamydospore suspension. After T. basicola was grown on 12 potato-dextrose agar plates for 10 days, plates were flooded with 5 mL each of sterile deionized (DI) water, then lightly scraped to detach mycelia. The water/mycelium solution was poured first through a 400-micrometer mesh filter, and then through a 500-micrometer mesh filter. The 500-micrometer mesh was flipped upside down, placed over a sterile beaker, and rinsed with sterile DI water to catch the chlamydospores. The chlamydospore suspension was placed in a Waring blender and blended on high-speed setting for 1 minute. The sieving process was repeated, and the final chlamydospore suspension was produced by rinsing the 500-micrometer mesh with 25 mL of DI water into a sterile beaker. A hemocytometer was used to determine the concentration of chlamydospores in the solution.

### Step 2. Development of an Inoculation System For Each Pathogen

Greenhouse trials were conducted with tomato (cv. Brandywine OG) and cantaloupe (cv. Sweet Granite OG) using established protocols for incorporation of each pathogen into growing media to establish that: 1) the pathogen was able to cause disease symptoms on each host within 3 to 4 weeks after seeding; 2) the plants appeared healthy in non-infested control media after 3 to 4 weeks; and 3) we found an intermediate inoculum density that caused symptoms within 3 to 4 weeks but did not immediately kill seedlings or transplants.

“Heirloom” tomato and muskmelon cultivars were chosen for the trials in order to minimize the possibility of significant genetic resistance to any of the pathogens under test.

Experimental design was a randomized complete block with 6-cell plug trays as replications and 3 replicate plug trays per treatment. Treatments included a factorial combination of 5 pathogens and a non-inoculated control×4 inoculum levels (High, Medium, Low, None)×2 planting media×3 replicates per treatment.

The initial trial for F. oxysporum, T. basicola, and a non-inoculated control began on Jun. 19, 2015. After inconclusive results for T. basicola, this pathogen was re-tested on Aug. 3, 2015; for the re-test, the pH of the potting media was raised. Media used in the trials was Sunshine Mix #1 (Sun Gro Horticulture Canada Ltd., Seba Beach, AB) and Metro-Mix 830 (Sun Gro Horticulture Canada Ltd., Seba Beach, AB). Tomato and cantaloupe seeds were purchased from Johnny's Selected Seeds. Inoculum was applied to treatments in High (50 millet seeds/cell, or 150 cfu/g soil), Medium (10 millet seeds/cell or 100 cfu/g soil), or Low (Low =5 millet seeds/cell or 50 cfu/g soil) concentrations.

For millet-inoculated treatments initiated on June 19, 6-cell plug trays were filled with potting media. Inoculum was applied to individual cells and mixed with a probe. Treatments were randomly assigned a location. Seeds were then planted and watered in.

For millet-inoculated treatments initiated on August 3, potting media was premeasured for all treatments of each inoculum level. Inoculum was then bulk-mixed to reduce time spent mixing inoculum into individual plugs. Inoculated media was then used to fill 6-cell plug trays for each treatment. Plug trays were randomly assigned a location. Seeds were then planted and watered in.

For treatments inoculated with a spore suspension (T. basicola), 6-cell plug trays were filled with potting media. PH of soil was raised with a flowable dolomitic lime solution. After cantaloupe and tomato seeds were planted, inoculum solution was applied to individual cells according to treatment. Plug trays were randomly assigned a location.

Trays were watered as needed to maintain disease-favorable wetness microenvironment for each pathogen. Greenhouse conditions included 14 hours of daylight and temperatures ranging from 60 to 80° F.

Disease development was rated three times per week until the end of 4 weeks after seeding. For F. oxysporum, symptoms of disease began to appear on treatments with the high level of inoculum at the very end of 3 weeks. For T. basicola, symptoms appeared on melon early with high and medium inoculum levels respectively; and symptoms appeared on tomato only with the medium inoculum level of T. basicola. Plants in non-infested control media were healthy.

We advanced to Step 3 of the project. For F. oxysporum, we increased the level of inoculum to 75 grains of millet/cell. For T. basicola, we advanced using the medium inoculum level on both crops, but only in S1 soil.

### Step 3. Assessment of Impact of Carvacrol/Propionate on Suppression of Symptom Development.

Greenhouse trials were conducted to assess the impact of the carvacrol/propionate products (Formulation 3 from Table 4) on suppression of symptom development. Trials were based on preliminary results from Step 2.

Treatments included one or both crop plants (tomato and cantaloupe) depending on results for each pathogen in Part 2, F. oxysporum and T. basicola and a non-inoculated control, one or two types of growing media (S1 or MM830) depending on results for each pathogen in Part 2, four concentrations of the carvacrol/propionate product (0×, 1×, 5×, and 10×), and three replicates (6 cells each) per treatment. Experimental design was a randomized complete block.

Two separate trials were run. A trial starting on Jul. 31, 2015, tested F. oxysporum and a non-inoculated control. A second trial, starting on Oct. 18, 2015, included T. basicola, and a non-inoculated control. Treatments of each pathogen were prepared similarly to methods described in Step 2. For the first trial (July 31), inoculum and the carvacrol/propionate product were bulk-mixed into the soil before filling cells. For the second trial (October 18), the carvacrol/propionate product was bulk-mixed into the soil and pathogen was applied individually to cells and mixed with a probe in order to ensure equal levels of pathogen in each cell. Treatments were randomly assigned a location in both trials. Illumination and watering conditions matched those in Step 2. Symptom development was recorded three times per week until four weeks after seeding. Due to inconsistent results among tomato treatments in the July 31 trial, new tomato seeds of the same variety (Brandywine OG) were purchased from Gurney's Seed & Nursery Co. and used in the second trial.

### Results

In S1 soil infested with T. basicola, the mean percent incidence of symptomatic tomato plants declined as concentration of the carvacrol/propionate product increased (Table 7). Similarly, in S1 soil infested with F. oxysporum, disease incidence on cantaloupe declined as concentration of the carvacrol/propionate product increased (Table 7). There were statistically significant differences in incidence of plants with symptoms between the 10× and 0× concentrations, but no statistically significant differences between 0× and 1× or 5×, or between 10× and 1× or 5×.

Our results confirm that the carvacrol/propionate product can suppress certain soilborne diseases of seedling crops; specifically, those caused by Thielaviopsis basicola and Fusarium oxysporum.

TABLE 7
Disease Incidence

| | | |
|---|---|---|
| Fusarium | Thielaviopsis | Non-inoculated |

Melon, S1 soil

| | | | | | | |
|---|---|---|---|---|---|---|
| 0x | 44.44% | a | 0.00% | a | 2.78% | a |
| 1x | 33.33% | ab | 0.00% | a | 13.89% | a |
| 5x | 16.67% | ab | 5.56% | a | 11.11% | a |
| 10x | 0.00% | b | 0.00% | a | 2.78% | a |

Tomato, S1 soil

| | | | | | | |
|---|---|---|---|---|---|---|
| 0x | 83.33% | a | 22.22% | a | 19.44% | a |
| 1x | 50.00% | a | 16.67% | ab | 27.78% | a |
| 5x | 61.11% | a | 5.56% | ab | 16.67% | a |
| 10x | 38.89% | a | 0.00% | b | 30.56% | a |

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

### REFERENCES

1. Vilsack, T. and C. Clark. 2010. 2007 Census of agriculture, Census of horticulture specialties (2009). United States Department of Agrigulture, National Agriculture Statistics Service. Volume 3, Special Studies, Part 3. AC-07-SS-3.
2. Jarvis, W. R. 1992. Managing diseases in greenhouse crops. Saint Paul, Minn.: APS Press. ISBN 978-0-89054-122-7.
3. Perry, E. J. 2006. Pest Notes: Damping-off diseases in the garden, University of California Agricultural and Natural Resources Publication, 74132, http://www.ipm.ucdavis.edu/PDF/PESTNOTES/pndampingoff.pdf, accessed May 22, 2014).
4. Lévesque, C. A and A. W. M. de Cock. 2004. Molecular phylogeny and taxonomy of the genus Pythium. Mycological Research 108 (12): 1363-1383.
5. Lambert, R. J. W., P. N. Skandamis, P. J. Coote, and G. J. E. Nychas. 2001. A study of the minimum inhibitory concentration and mode of action of oregano essential oil, thymol and carvacrol. Journal of Applied Microbiology 91: 453-462.
6. Bakkali F., S. Averbeck, D. Averbeck, and M. Idaomar. 2008. Biological effects of essential oils—A review. Food and Chemical Toxicology 46: 446-475.
7. Brock, M. and W. Buckel. 2004. On the mechanism of action of the antifungal agent propionate. European Journal of Biochemistry 271: 3227-3241.
8. Edwards, S. G. and B. Seddon. 2001. Selective media for the specific isolation and enumeration of Botrytis cinerea conidia. Letters in Applied Microbiology 32:63-66.
9. Castellá, G., M. R. Bragulat, M. V. Rubiales, and F. J. Cabañes. 1997. Malachite green, a new selective medium for Fusarium spp. Mycopathologia 137:173-178.
10. Morita Y. and M. Tojo. 2007. Modification of PARP medium using fluazinam, miconazole, and nystatin for detection of Pythium spp. in soil. Plant Disease: 91: 1591-1599.
11. Qi, H. H. 2008. Accelerated carbon dioxide production test with moisture adjustment. K-Source: SOP-10-00018.
12. Khan, M. R., S. Ashraf, S. Shahid, and M. A. Anwer. 2010. Response of some chickpea cultivars to foliar, seed and soil inoculations with Botrytis cinerea. Phytopathologia Mediterranea 49: 275-286.
13. Bautista-Banos, S. and L. L. Barrera-Necha. 2001. Inoculum variables affecting pathogenicity of Botrytis cinerea infection of kiwifruit. Mexican Journal of Phytopathology 19: 161-167.
14. Zhou, X. G. and K. L. Everts. 2004. Suppression of Fusarium wilt of watermelon by soil amendment with hairy vetch. Plant Disease 88: 1357-1365.
15. Holmes, K. A., S. D. Nayagam, and G. D. Craig. 1998. Factors affecting the control of Pythium ultimum damping-off of sugar beet by Pythium oligandrum. Plant Pathology 47: 516-522.

We claim:

1. A method of controlling microbial growth in soilless potting media, comprising application of an effective amount of a combination of carvacrol and propionic acid.

2. A method of controlling microbial growth in soilless potting media, comprising application of an effective amount of carvacrol and propionate.

3. A composition, comprising soilless potting media, carvacrol, and propionic acid.

4. A composition, comprising soilless potting media, carvacrol and propionate.
